(19) United States
(12) Patent Application Publication
(10) Pub. No.: US 2004/0024691 A1
(43) Pub. Date: Feb. 5, 2004

(54) Anti-manipulation method and system for a real-time computerized stock trading system

(75) Inventors: Michael Satow, New York, NY (US); Eugene Choe, Cliffside Park, NJ (US); Michael Hermus, New York, NY (US); Stanley Leong, Bayside, NY (US)

Correspondence Address: Kamran Khan, 31st Floor, 135th East 57th Street, New York, NY, 10022, US

(73) Assignee: MarketXT, Inc.

(21) Appl. No.: 10/633,515

(22) Filed: Aug. 5, 2003

Related U.S. Application Data
(63) Continuation of application No. 09/376,309, filed on Aug. 18, 1999, now abandoned.
(60) Provisional application No. 60/097,414, filed on Aug. 21, 1998.

(51) Int. Cl. G06F 17/60

(52) U.S. Cl. 705/37

(57) ABSTRACT

A system protects against intentional market manipulation in a computerized real-time stock trading system. It determines whether users are attempting to manipulate the trading system's market using schemes such as self-trading and round-robin trading to create a false appearance of trading activity. The trading system matches buy and sell trade orders placed by different users on the system, and the anti-manipulation component receives unique identifiers for each trade order that identify the users placing the trade order. The anti-manipulation component then compares the identifiers to determine, flag and reject artificial manipulation of the trading system's market. These defensive systems may be used in real time stock trading systems that provide after-hours stock trading to both retail and institutional investors.

### RELATED APPLICATIONS

This patent application claims priority to Provisional U.S. patent application Ser. No. 60/097,414, entitled “Online Trading System” and filed on Aug. 21, 1998, which is herein incorporated by reference.

The following identified U.S. patent applications are relied upon and are incorporated in their entirety by reference in this application.

U.S. patent application Ser. No. ______, entitled “A Real-Time Computerized Stock Trading System” bearing attorney docket no. 07444.0001, and filed on the same date herewith.

U.S. patent application Ser. No. ______, entitled “Volume Limitation Method and System for A Real-Time Computerized Stock Trading System” bearing attorney docket no. 07444.0013° and filed on the same date herewith.

### BACKGROUND

The present invention relates generally to stock trading, and more particularly to a method and system for protecting against intentional market manipulation in a real-time computerized stock trading system.

Most trading environments with many investors have “liquidity,” which is a level of trading volume that makes it easy to buy or sell a particular security. In simple terms, there are many of buyers, sellers, and trades. The most important thing that liquidity provides is price efficiency: the more liquidity, the more efficient the market, and the closer the price will be to the “true” price (in a perfectly efficient market). This makes it very difficult for one person or organization to affect the market or the price of the secures.

Some trading environments are illiquid; however, and thus susceptible to manipulation. A trading environment may be illiquid if it does not have enough trades on it, thus causing situations in which there are not enough buyers for the sellers, or vice versa. Such illiquid trading environments may be manipulated by investors and users. One such form of manipulation is “self-trading,” in which an individual investor trades with himself and sets any price he wishes because he is not losing or gaining any money. The ability to set trading prices can create the appearance of the market moving up or down, when in actuality, no real trading is occurring. Through self-trading, an individual can create the appearance of stock prices skyrocketing or plummeting without losing money, thus creating an adverse effect on the illiquid market. “Round-robin” trading, in which several investors trade amongst themselves in effect creating self-trading within a small group, can similarly manipulate the market.

### SUMMARY

A method for protecting against manipulation in a data processing system for trading stocks is provided that receives a trade order from a first user and a second trade order from a second user. It assigns an identifier to the first trade order, the identifier uniquely identifying the first user. Similarly, it assigns a second identifier to the second trade order, the identifier uniquely identifying the second user. Finally, it compares the first and second identifiers to compare the first and second identifiers to control the trading of stocks.

In accordance with another aspect of the present invention, a method is provided that determines whether a first user has executed trades with a second user more than a predetermined number of times and identifies the users based on the determination.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 illustrates a block diagram of a real-time computerized trading system with an anti-manipulation component in accordance with the present invention;

FIG. 2 displays a flowchart illustrating the steps of a method for placing a trade order in the trading system in accordance with the present invention;

FIGS. 3A, 3B and 3C depict exemplary broker-dealer order entry screens in accordance with the present invention;

FIG. 4 illustrates the steps of a method for matching a trade order in the trading system in accordance with the present invention;

FIG. 5 depicts the steps of a method for publishing the trading system market information over a network, such as the Internet, in accordance with the present invention;

FIG. 6 shows a market information mechanism in accordance with the present invention;

FIG. 7 depicts the steps of a method for detecting self trading market manipulation in a trading system in accordance with the present invention; and

FIG. 8 depicts the steps of a method for detecting round-robin market manipulation in a trading system in accordance with the present invention.

### DETAILED DESCRIPTION

Methods and systems consistent with the present invention protect against and/or detect market manipulation in real-time computerized stock trading systems. These stock trading systems may provide trading environments that do not have a high level of liquidity and may thus be susceptible to intentional malicious manipulation of the trading system's market. Two such forms of market manipulation are self-trading and round-robin trading, wherein a user trades with himself or a small group of other users to artificially manipulate the market. The self-trades and round-robin trades can intentionally create false impressions of the market moving up or down without the manipulating user or users risking any money. For instance, if a user buys up all outstanding orders for a particular stock, the user may then put in sell orders at high prices and buy them back from himself to create an impression that the stock price is rising or falling without actually risking any money. Methods and systems are provided to flag or reject such trades.

In accordance with the present invention, an identifier uniquely identifying a user is applied to the trade order placed by the user. This unique identifier associated with the individual trade order is compared with the identifiers on matching trade orders with which the placed trade order would be executed. The anti-manipulation system then uses the identifiers to flag or reject trade orders placed to intentionally manipulate the trading system's market.

In accordance with another aspect of the present invention, the system determines whether a first user has traded with a second user more than a predetermined number of times and identifies users based on the determination to detect round-robin trading.

To describe methods and systems in accordance with the present invention, first, an example of a real-time computerized trading system is described. This trading system is similarly described in co-pending U.S. patent application Ser. No. ______. It describes a real-time, after-hours computerized trading system that provides trading to both retail and institutional users and may utilize anti-manipulation methods and systems consistent with the present invention. It should be noted that after-hours refers to any time outside of exchange trading hours, i.e., any time the primary securities exchanges such as the New York Stock Exchange and the American Stock Exchange do not accept for immediate execution purchase or sale orders for securities, including before the exchanges open. The description of the system is followed by description of anti-manipulation methods and systems in accordance with the present invention.

Trading System

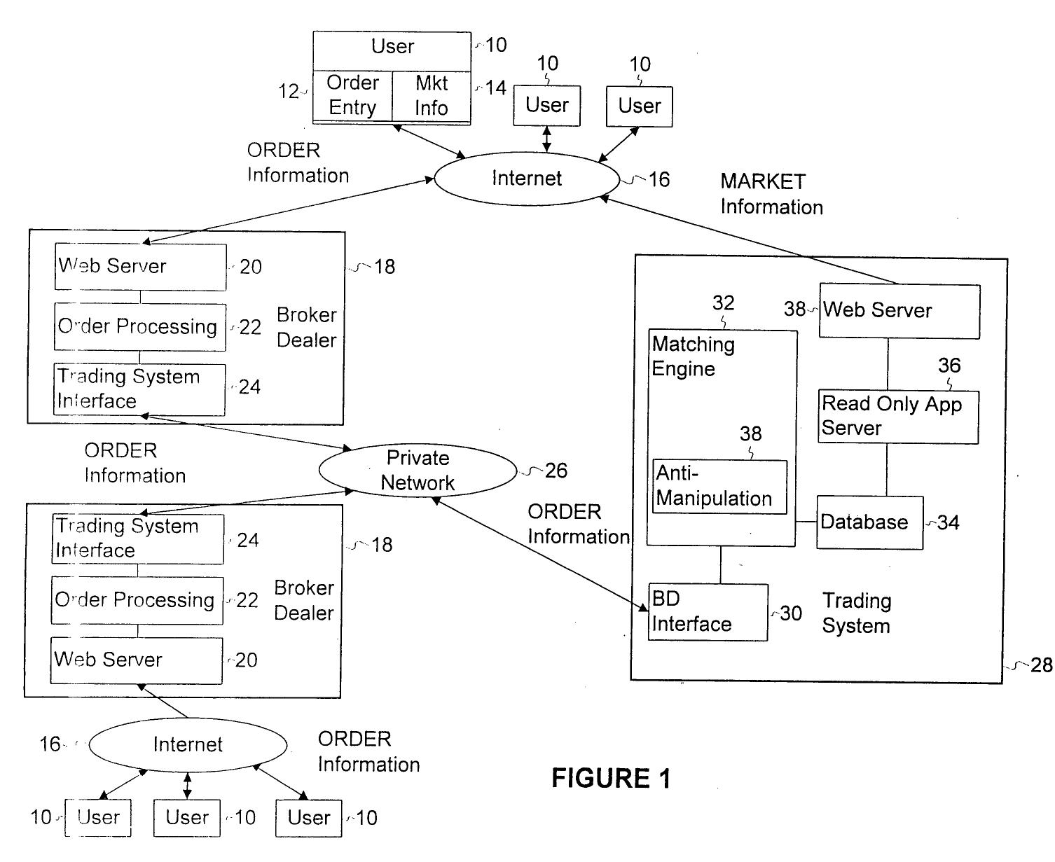

FIG. 1 illustrates a block diagram of an exemplary real-time computerized trading system consistent with the present invention. Retail or institutional investors, referred to as users 10, may access the trading system 28 directly through their personal computers using the existing online trading networks of their brokerage firms, referred to as broker-dealers 18 (“BD”). The trading system 28 contains the anti-manipulation component 38 which may be implemented as software or hardware and is described below. Online investors' trades may be filtered through their broker-dealers' computer systems, as they currently are, to ensure that the investors' accounts contain necessary buying power and meet requirements imposed by the broker dealers 18 for the transactions there wish to conduct on the system. However, the user 10 does not necessarily have to connect to the system through a brokerage firm, and the connection may be directly to the trading system 28 or by other means. Additionally, users 10 may also be broker-dealers 18.

The computer systems used by users 10, broker-dealers 18, and the trading system 28 may be general-purpose computers that run the necessary software or contain the necessary hardware components for implementing methods consistent with the present invention, and these computer systems may have additional components not shown on FIG. 1. Furthermore, although two broker-dealers 18 and six users 10 are shown on the figure, any number of broker-dealers 18 and users 10 may use the trading system 28 in accordance with the present invention.

The various software components of a system consistent with the present invention may be programmed in a programming language such as the Java™ programming language, which is further described in “The Java programming Language,” 2^{nd} Ed., Ken Arnold, James Gosling, Addison-Wesley, 1998, which is incorporated herein by reference. For further description of the Java, language, refer to “The Java™ Language Specification,” James Gosling, Bill Joy, Guy Steele, Addison-Wesley, 1996 and is also incorporated herein by reference. When programmed in the Java programming language, the source code for the software is portable across multiple operating systems (i.e., Unix, NT, etc.) and easily deployed over the Internet, but other programming languages may also be used.

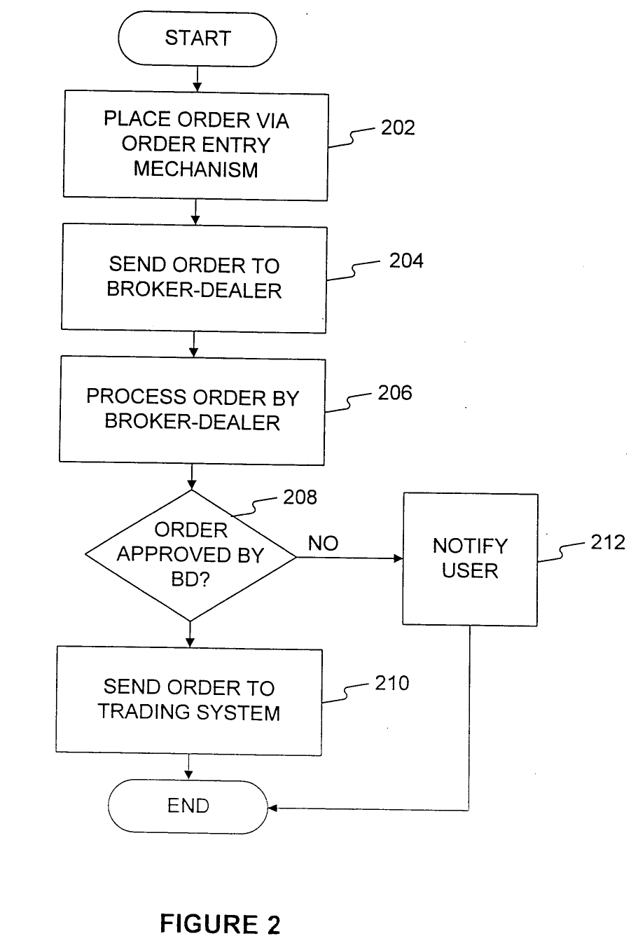

FIG. 2 illustrates a flowchart of the steps of a method for placing a trade order in the trading system in accordance with the present invention. Generally, a user 10 enters a trade order through the order entry mechanism 12 that is, in one implementation, supplied by the broker-dealer 18 (step 202). The order entry mechanism 12 may be an applet containing screens used to interface with the broker-dealer 18. The user 10 may make decisions on various trades based on information from the market information mechanism 14, which will be described below.

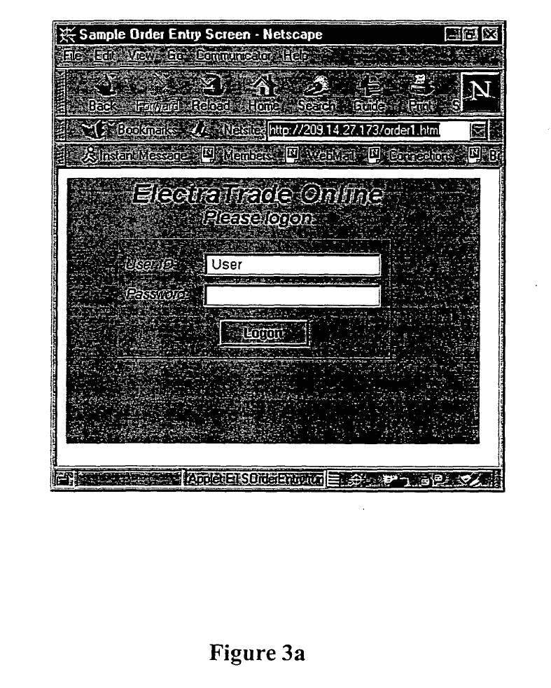

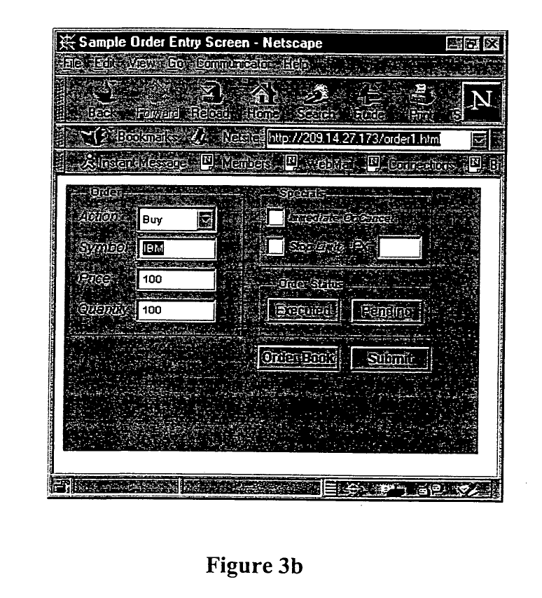

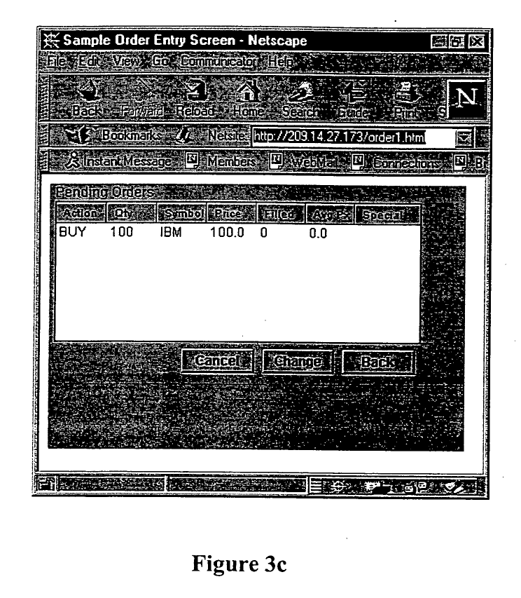

FIG. 3A illustrates an exemplary broker-dealer's initial order entry screen in the order entry mechanism 12. Shown on the screen is a user identification and a password log on. The screens supplied to the user 10 in the order entry mechanism 12 may be the standard screens currently given to the user by a broker-dealer 18 with online capabilities, and they may vary greatly from the ones shown in the drawings.

FIG. 3B shows the next exemplary screen contained in the order entry mechanism 12 given to the user 10. On this screen, the user 10 may decide whether to buy or sell an amount of a certain type of stock at a specific price. For example, the screen in FIG. 3B shows a user 10 placing an order to buy 100 shares of IBM stock at one hundred dollars per share.

FIG. 3C depicts the following exemplary screen contained in the order entry mechanism 12. This screen displays pending open orders for the exemplary user 10. As shown on the figure, the screen shows a user 10 placing an exemplary buy order for 100 shares of IBM stock at 100 shares, and it shows that the buy order has not yet been filled.

Referring back to FIG. 1 and FIG. 2, information entered by the user 10 to the order entry mechanism 12 travels to the broker-dealer 18 via a network 16 such as the Internet (step 204). This network 16 facilitates the transferring of order entry information to and from the user 10 by the broker-dealer 18. As discussed below, it also facilitates the publication of the real-time market information to the user 10 from the trading system 28.

In one system consistent with the present invention, when the user 10 communicates across the network 16 with the broker-dealer 18, it does so via the broker-dealer web server 20. The broker-dealer web server 20 is the broker web site which, in one implementation, hosts the order entry mechanism 12 which the user 10 utilizes to enter trade orders. Once a trade order is entered, it is then relayed from the broker-dealer web server 20 to order processing 22 on the broker-dealer 18.

Order processing 22 is a “black box” representation of a broker dealer's back-end system that performs order verification, updates account positions (i.e., cash and securities), updates buying power, etc. Before the trade order is routed for execution (to the principal market exchanges or to the trading system 28 described below), order processing 22 verifies the order to make sure the user's account has the cash, securities or buying power to make the transaction (step 206). If approved (step 208), order processing 22 routes the trade order to the trading system interface 24, which is a software component that forwards the order information to the trading system 28 across a private network 26 (step 210). If the trade order is not approved by the BD 18, the BD notifies the user 10 (step 212).

In one implementation consistent with the present invention, the private network 26 is a private leased line network for security and performance advantages. Private leased lines are essentially telephone lines that are leased from a phone company for exclusive use. They are secure because only one system uses the lines, and they offer better performance because the system does not share bandwidth with other systems or businesses. Although the private network 26 realizes some advantages, a public network may also be used.

The trading system interface 24 represents the order approving mechanism by which orders are translated and transmitted from the broker-dealer 18 to the trading system's broker-dealer interface 30. The trading system interface 24 receives order confirmation and execution information from the broker-dealer interface 30 after the order has been processed by the trading system 28. After execution on the trading system 28 (described below), the order execution information is relayed back to the trading system interface 24 and then to order processing 22. The order execution information received from the trading system 28 is used to update the account position and buying power in the account by the broker-dealer 18.

When a broker-dealer 18 routes orders and communicates with the trading system 28, it preferably communicates using the Financial Information Exchange protocol (“FIX”), a protocol developed by the securities industry to standardize communications between brokerage firms. Alternatively, the broker-dealers 18 and the trading system 28 may use other communication protocols.

The configuration and implementation of order processing 22 may vary widely among broker-dealers 18. Most notably, numerous broker-dealer 18 firms outsource order processing 22 to third party broker-dealers called “clearing firms” which perform order processing 22 and other back-office functions for multiple client broker-dealers firms. In this case, as indicated in FIG. 1, the link between the trading system 28 and the broker-dealer 18 (which, as shown on FIG. 1, is comprised of the trading system interface 24, private network 26, and BD Interface 30) is through the clearing firm.

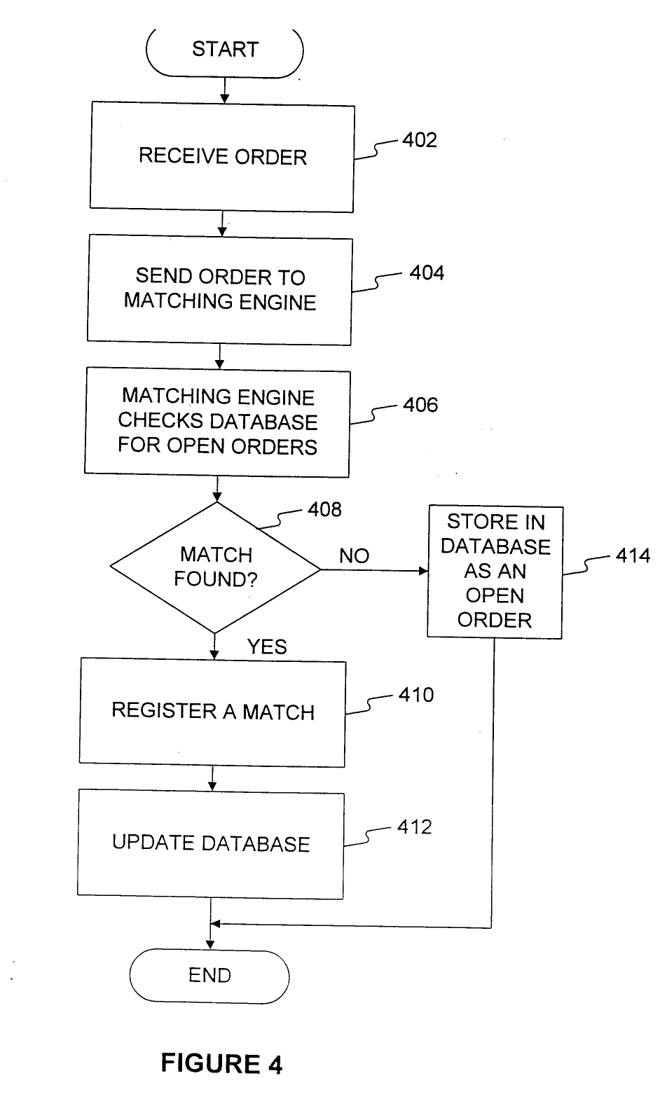

FIG. 4 illustrates the steps of a method for matching a trade order in the trading system in accordance with the present invention. The BD interface 30 on the trading system 28 is the component which receives orders from the BD 18 and sends confirmation/execution information back to the BD (step 402). It translates communications to the trading system 28 application programming interface (API), a formal set of specifications for one program to communicate th another program, which it uses to communicate with the matching engine 32 (step 404).

The matching engine 32 is the software component of the trading system 28 which actually performs order matches and executions. In one implementation consistent with the present invention, all of the matching logic (including anti-manipulation and other defensive schemes) is contained in the matching engine 32. In this implementation, the anti-manipulation component 38 (described below) is shown in the matching engine 32, although other implementations may have it located elsewhere. When the matching engine 32 receives trade orders, it checks the database 34 for open orders to be matched (step 406), determines if a match is made (step 408) and updates the database 34 accordingly. For example, if one user 10 has placed an order to sell a certain number of shares of a specific stock, and another user 10 has placed an order to buy a certain number of shares of the same stock, and their prices match, the matching logic in the matching engine 32 registers a match (step 410). The matching engine 32 determines how many shares of that stock will change possession from the seller to the buyer.

Generally, orders that cross the market will result in execution at the best counterpart price currently offered on the trading system 28. If a user does not wish to buy as many shares as a seller is offering, partial order matches may be executed and the remaining quantity of the larger order may remain open and post back to the trading system 28 to be matched. If a match is determined between two trade orders, the matching engine 32 executes the order immediately and relays the order execution information to the database 34 for persistent storage (step 412). If the matching engine 32 does not find a matching open order for the received trade order, the trade order is stored in the database 34 as an open order to be matched with future trade orders (step 414).

The database 34 is the central repository for information in the trading system 28, including open orders, execution information, and audit trails. In one implementation consistent with the present invention, the database server 34 is an object-oriented database, although other types of databases may also be used. The database 34 on the trading system 28 stores the order information used by the matching engine 32 to determine a match. In doing so, it stores data relating to open orders and executed orders, in addition to other relevant data for the trading system 28.

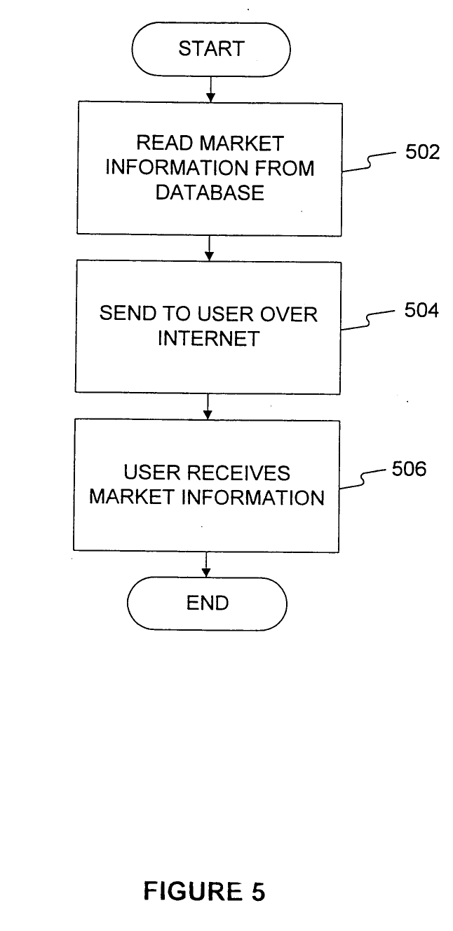

FIG. 5 depicts the steps of the method for publishing the trading system market information over a network, such as the Internet, in accordance with the present invention. While receiving and executing trade orders, the trading system 28 may also publish its market information in real-time over a network such as the Internet 16. The Read-Only Applet Server 36 on the trading system 28 reads market information to be displayed over the Internet 16. It receives the market information from the database 34 (step 502) and relays it to the user 10 via the trading system web server 38, which is the trading system web site that sends the market information over the Internet 16 (step 504). The trading system web server 38 hosts the market information mechanism 14, utilizing data from the Read-Only Applet Server 36. This market information mechanism 14 may contain an applet, referred to as an “order book,” showing open orders in the trading system 28 to the user 10 (step 506).

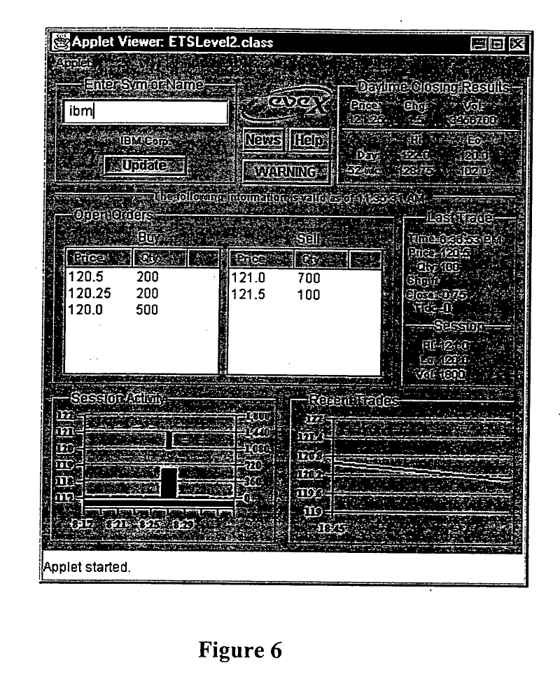

FIG. 6 illustrates an exemplary order book in accordance with the present invention. The order book provides real-time quotations of all open trade orders on the trading system 28, grouped by security and listed by price and time of entry, for example. Besides enabling users 10 of the trading system 28 to identify and follow their own orders on the trading system, the order book may also display additional information such as a stock's closing price for the day on the principal market including price, volume, high and low prices, and the price change for the day. It may also display the last price at which a stock was executed on the trading system 28 and the quantity and time of the trade. Additionally, the order book may give other information such as the price change from the closing price for the day on the principal markets, the chart of prices and times of all executions in that stock during the session, and session high, low and volume information for the stock.

Some implementations consistent with the present invention may further display additional information to keep the users 10 informed. This information may include a list of the most active stocks during a particular session, indications of price swings of more than a particular percentage (e.g., 10 percent), from the stocks closing price during a session. Furthermore, the order book may publish information regarding the types of orders that can be entered, in addition to real-time, after-hours news for use by all participating users 10 on the trading system 28 and the general public.

Anti-Manipulation

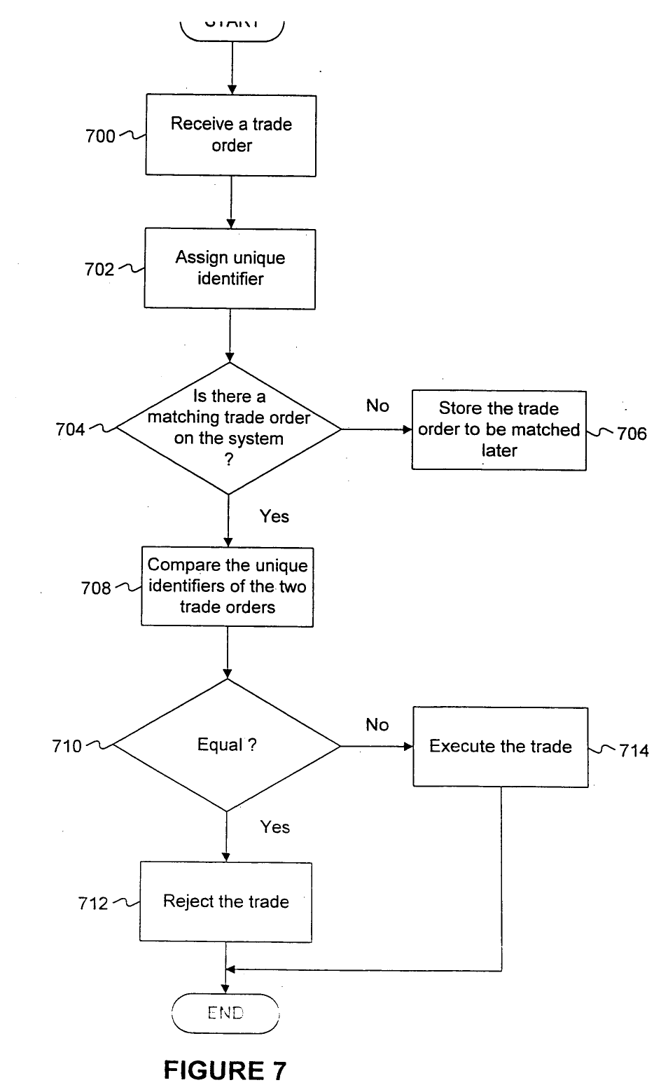

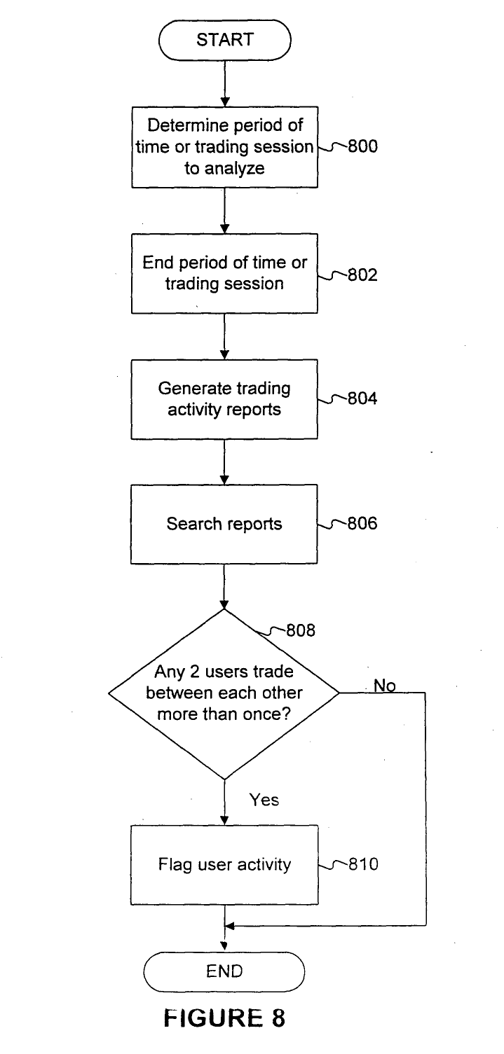

FIG. 7 illustrates the steps used in a method for anti-manipulation of a trading system in accordance with the present invention. In one implementation in accordance with the present invention, the anti-manipulation component 38 identifies intentional market manipulation, rejects or flags suspect trades, and performs related functions. Initially, when the trading system 28 receives a trade order (step 700), it assigns a unique identifier to the trade order, and the anti-manipulation component 38 receives the unique identifier (step 702). This identifier uniquely identifies the identity of the user 10 placing the trade order, and consequently, all trade orders on the trading system 28 are traceable to a specific user 10 for the purpose of identifying intentional malicious market manipulation. The unique identifier may be, for example, the user's Social Security number or a number derived from the Social Security number, such as the last several digits, although other identifiers may be used to identify the user 10 placing the trade order. In another implementation in accordance with the present invention, the unique identifier is a combination of a code derived from the user's BD account number and code that identifies the user's BD.

The anti-manipulation component 38 operates when the matching engine 32 searches for a match for the received trade order (step 704). If the matching engine 32 finds no match for the trade order, the trade order is stored to be matched later as previously described (step 706). However, if the matching engine 32 determines that there is a matching trade order on the trading system 28, the anti-manipulation component 38 compares the unique identifiers of the two matching trade orders (step 708). If the identifiers are determined to be equal (step 710), the anti-manipulation component 38 rejects the trade or identifies the trade as self-trading or a market manipulation (step 712). If they are not determined to be equal, the trade executes (step 714).

For round-robin trading, the anti-manipulation component 38 performs detection of manipulation either during trading activity or after a period of trading activity time, such as a day's trading session. In one implementation consistent with the present invention, the anti-manipulation component 38 analyzes trading activity automatically at the end of a trading session. The analyzed period of time may vary, and a system administrator or programmer determines the period of time or trading session to analyze (step 800). When the trading session ends (step 802), the trading system 28 generates electronic trading activity reports containing information on executed trades and the users 10 involved in each trade transaction (step 804). These reports may be in the form of database information so that they may be analyzed by computer software.

The anti-manipulation component 38 then searches the trading activity reports for potentially suspect trades (step 806). If it determines that any two users 10 have traded between each other more than once in the trading session (step 808), it identifies or flags the users' activity (step 810) for a system administrator or analyst. In doing so, the system searches for two or more trades between two users 10; the trades may be for different securities and may go either way, i.e., buy or sell, between the users 10. Once the trading activity has been automatically identified by the trading system 28, the system administrator may determine whether the identified trades are actually an attempt at manipulating the trading system.

This manner of detecting round-robin manipulation detects simple round-robin trading between two users and more complex round-robin trading between multiple users. It assists in the detection of complex round-robin trading because it identifies individual sections of larger, more complex trading circles or schemes, and the larger scheme may be identified using the individual sections. Over longer periods of time, larger, more complex schemes may use the same individual two users 10 repeatedly as part of their schemes, thus making their detection easier.

Furthermore, although described in this implementation as being performed after the closing of a trading session, analysis of whether two users 10 have traded with each other more than once in a trading session may be performed in real-time and during the trading session. If operating in real-time, the anti-manipulation component 38 and trading system 28 may be configured not to automatically reject potential round-robin trades and simply to identify them for separate analysis in order to avoid accidentally rejecting purely coincidental trades.

The foregoing description of an implementation of the present invention has been presented for purposes of illustration and description. It is not exhaustive and does not limit the present invention to the precise form disclosed. Modifications and variations are possible in light of the above teaching or may be acquired from practicing of the present invention. The scope of the present invention is defined by the claims and their equivalents.

What is claimed is:

1. A method for protecting against manipulation in a data processing system for trading stocks, the method comprising:
receiving a first trade order to be executed in real-time outside of exchange trading hours from a first non-institutional user;
receiving a second trade order to be executed in real-time outside of exchange trading hours from a second non-institutional user;
assigning a first identifier to the first trade order, the first identifier uniquely identifying the first user;
assigning a second identifier to the second trade order, the identifier uniquely identifying the second user; and
comparing the first and second identifiers to control the trading of stocks.

2. The method of claim 1, further including:
rejecting the trade if the first identifier is the same as the second identifier.

3. The method of claim 1, further including:
identifying the trade if the first identifier is the same as the second identifier.

4. The method of claim 1, wherein the identifier is the social security, number of the user.

5. The method of claim 1, wherein the identifier is derived from the social security number of the user.

6. The method of claim 1, wherein the identifier is a combination of a code derived from the user's broker-dealer account number and code that identifies the user's broker-dealer.

7. A method for protecting against manipulation in a data processing system for trading stocks, the method comprising:
receiving a first trade order from a first user;
receiving a second trade order from a second user;
assigning a first identifier to the first trade order, the first identifier uniquely identifying the first user;
assigning a second identifier to the second trade order, the identifier uniquely identifying the second user; and
comparing the first and second identifiers to control the trading of stocks.

8. A method for protecting against manipulation in a data processing system for trading stocks, the method comprising:
determining whether a first non-institutional user has executed trades with a second non-institutional user outside of exchange trading hours in real-time more than a predetermined a number of times; and
identifying the first and second users based on the determination.

9. The method of claim 8, wherein the identifying step includes the step of:
identifying the trades between the first and second users.

10. The method of claim 8, further comprising the steps of:
specifying a period of time; and
wherein the determining step further includes the step of determining whether the first user has traded with the second user more than the predetermined number of times within the specified period of time.

11. A method for protecting against manipulation in a data processing system for trading stocks, the method comprising:
determining whether a first user has executed trades with a second user more than a predetermined number of times; and
identifying the first and second users based on the determination.

12. A computer-readable medium containing instructions for controlling a data processing system to perform a method for protecting against manipulation in a data processing system for trading stocks, the method comprising:
receiving a first trade order to be executed in real-time outside of exchange trading hours from a first non-institutional user;
receiving a second trade order to be executed in real-time outside of exchange trading hours from a second non-institutional user;
assigning a first identifier to the first trade order, the first identifier uniquely identifying the first user;
assigning a second identifier to the second trade order, the identifier uniquely identifying the second user; and
comparing the first and second identifiers to control the trading of stocks.

13. The computer-readable medium of claim 12, further including:
rejecting the trade if the first identifier is the same as the second identifier.

14. The computer-readable medium of claim 12, further including:
identifying the trade if the first identifier is the same as the second identifier.

15. The computer-readable medium of claim 12, wherein the identifier is the social security number of the user.

16. The computer-readable medium of claim 12, wherein the identifier is derived from the social security number of the user.

17. The computer-readable medium of claim 12, wherein the identifier is a combination of a code derived from the user's broker-dealer account number and code that identifies the user's broker-dealer.

18. A computer-readable medium containing instructions for controlling a data processing system to perform a method for protecting against manipulation in a data processing system for trading stocks, the method comprising:
receiving a first trade order from a first user;
receiving a second trade order from a second user;
assigning a first identifier to the first trade order, the first identifier uniquely identifying the first user;
assigning a second identifier to the second trade order, the identifier uniquely identifying the second user; and
comparing the first and second identifiers to control the trading of stocks.

19. A computer-readable medium containing instructions for controlling a data processing system to perform a method for protecting against manipulation in a data processing system for trading stocks, the method comprising:
determining whether a first non-institutional user has executed trades with a second non-institutional user outside of exchange trading hours in real-time more than a predetermined a number of times; and
identifying the first and second users based on the determination.

20. The computer-readable medium of claim 19, wherein the identifying step includes the step of:
identifying the trades between the first and second users.

21. The computer-readable medium of claim 19, further comprising the steps of:
specifying a period of time; and
wherein the determining step further includes the step of determining whether the first user has traded with the second user more than the predetermined number of times within the specified period of time.

22. A computer-readable medium containing instructions for controlling a data processing system to perform a method for protecting against manipulation in a data processing system for trading stocks, the method comprising:
determining whether a first user has executed trades with a second user more than a predetermined number of times; and
identifying the first and second users based on the determination.

23. An anti-manipulation system for a real-time computerized stock trading system, comprising:
a receiving component configured to receive a first and a second trade order outside of exchange trading hours from first and second non-institutional users;
a matching engine configured to match the received first and second trade orders and execute trades between matching trade orders in real-time between the users that placed the trade orders; and
an anti-manipulation component receiving the first and a second trade order and applying a unique identifier to each trade order, the unique identifiers uniquely identifying the user placing the trade order, the anti-manipulation component comparing the unique identifiers of the first and second trade orders to determine market manipulation of the trading system when the two trade orders are determined to be matching trade orders.

24. An anti-manipulation system for a real-time computerized stock trading system, comprising:
a receiving component configured to receive a first and a second trade order;
a matching engine configured to match the received first and second trade orders and execute trades between matching trade orders between the users that placed the trade orders; and
an anti-manipulation component configured to determine whether a first user has traded with a second user two or more times and identify the first and second users based on the determination.

25. An anti-manipulation system for protecting against market manipulation in a data processing system for trading stocks, comprising:
means for receiving a first trade order to be executed in real-time outside of exchange trading hours from a first non-institutional user;
means for receiving a second trade order to be executed in real-time outside of exchange trading hours from a second non-institutional user;
means for assigning a first identifier to the first trade order, the first identifier uniquely identifying the first user;
means for assigning a second identifier to the second trade order, the identifier uniquely identifying the second user; and
means for comparing the first and second identifiers to control the trading of stocks.
